(19) United States
(12) Patent Application Publication
(10) Pub. No.: US 2005/0007458 A1
(43) Pub. Date: Jan. 13, 2005

(54) Standalone remote video surveillance device

(76) Inventor: Frederic Benattou, Oceanside, CA (US)

Correspondence Address: SUGHRUE MION, PLLC, 2100 PENNSYLVANIA AVENUE, N.W., SUITE 800, WASHINGTON, DC, 20037, US

(21) Appl. No.: 10/845,457

(22) Filed: May 14, 2004

Related U.S. Application Data
(60) Provisional application No. 60/470,232, filed on May 14, 2003.

(51) Int. Cl. H04N 5/232

(52) U.S. Cl. 348/211.99

(57) ABSTRACT

Disclosed is a remote, standalone video surveillance device which wirelessly transmits video data in a plurality of types of transmission signals, simultaneously. The device includes one or more video acquisition modules which acquire a video signal, process the video signal, and output the processed video signal; one or more wireless transmission modules which transmit the output video signal; and a power supply which provides power to the video acquisition modules and the wireless transmission modules. Also, the device provides for wired transmission of video data, as well as the wireless transmission.

### CROSS REFERENCE TO RELATED APPLICATION

This application claims the benefit of U.S. Provisional Application No. 60/470,232 filed May 14, 2003, the disclosure of which is incorporated herein by reference in its entirety.

### BACKGROUND OF THE INVENTION

1. Field of the Invention

The present invention relates to a remote, standalone video surveillance device, and more particularly to a remote, standalone video surveillance device, which wirelessly transmits video data through a plurality of types of transmission modules, simultaneously.

2. Description of the Related Art

In a conventional video surveillance device only one type of video transmission is provided at a time. Thus, the conventional device is limited in its ability to transmit the video data.

In the typical conventional device, video transmission is via telephone lines. Generally, one telephone line would be used for video transmission and another telephone line would be needed to provide control signals to move a camera, which provides the video signal. Such a system is limited by the requirement for connection to telephone lines.

### SUMMARY OF THE INVENTION

The present invention has been made to overcome the above-mentioned problems of the prior art. Accordingly, it is an aspect of the present invention to provide a video surveillance device, which can provide a plurality of wireless video transmissions simultaneously.

The above aspect of the present invention is realized by providing a remote, standalone video surveillance device which wirelessly transmits video data in a plurality of types of transmission signals, simultaneously.

### BRIEF DESCRIPTION OF THE DRAWINGS

The above-mentioned features of the present invention will be more apparent by describing the exemplary embodiments of the present invention by referring to the appended drawings, in which:

FIG. 1 is a block diagram showing the structure of a video surveillance device according to an illustrative embodiment of the present invention;

FIG. 2 is a block diagram showing the structure of a video surveillance device according to an illustrative embodiment of the present invention, which includes a power management board;

FIG. 3 is a block diagram showing the structure of a video surveillance device according to another illustrative embodiment of the present invention.

### DESCRIPTION OF ILLUSTRATIVE EMBODIMENTS OF THE PRESENT INVENTION

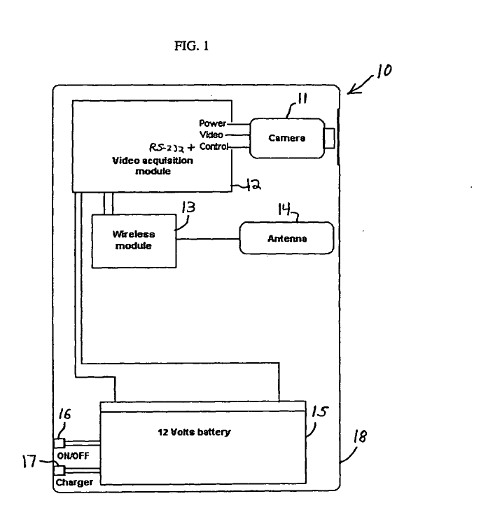

Hereinbelow, the present invention will be described in greater detail by referring to FIG. 1. In an illustrative embodiment of the present invention, a standalone, remote video surveillance device will be described.

As shown in FIG. 1, an illustrative embodiment of a video surveillance device 10 includes: a camera 11, a video acquisition module 12, a wireless transmission module 13, an antenna 14, a battery 15, an ON/OFF switch 16, a charger connector 17, and a weatherproof enclosure 18. The camera 11, which outputs a video signal, has pan, tilt, and zoom (PTZ) functions, which can be controlled through a serial connection and protocol integration in remote monitoring software in a remote monitoring device. The particular type of camera used is selectable by the user.

The video acquisition module 12 acquires an analog or digital video signal from the camera 11. Also, the video acquisition module 12 can acquire its signal from a source other than the camera 11. The video acquisition module 12 digitizes the acquired video signal, compresses the digitized video signal, and provides a video output signal to the wireless transmission module 13.

Although users may typically choose to use one camera 11, more than one camera can be used in the video surveillance device 10 of the present invention.

The video surveillance device 10 may also include one or more alarm inputs such as an alarm sensor, motion detection sensor, telemetry equipment, etc., which allow the video surveillance device 10 to call a user when an event is triggered by one of the sensors. When one or more alarm inputs are used, monitoring software at the receiving end of the system which receives the transmission of the video data is in “wait for alarm” mode.

The video surveillance device 10 can include one or more outputs used to trigger a remote device, such as, but not limited to, relays which act as on/off switches to turn camera power on/off, turn a light on/off, activate an infrared illuminator for night vision applications, etc.

Also, the video surveillance device 10 may include a serial port for remotely controlling a separate device, such as, but not limited to, a camera with pan, tilt, and zoom features, a telemetry device, a weather station, various sensors, etc. The serial port can also transmit data generated by the separate device. The transmitted data can be displayed on the remote monitoring device in association with the transmitted video data, either embedded in a video window or as a separate window.

The wireless transmission module 13 receives the video output signal from the video acquisition module 12 and outputs to the antenna 14 a video signal for transmission. The aforementioned alarm inputs, remote device outputs, and serial port are connected to the video acquisition module 12.

The wireless transmission module 13 of the present embodiment is a cellular wireless transmission module, which operates in accordance with the Global System for Mobile Communication (GSM) and Global Packet Radio Service (GPRS) standards, i.e., a GSM/GPRS transmission module. Examples of the GSM/GPRS module include: “Integra” made by WaveCom, “G18” made by Motorola, and “GM47” made by Sony-Ericson.

However, other cellular wireless transmission modules may be used, such as a cellular wireless transmission module that operates in accordance with the Code Division Multiple Access (CDMA) standard, i.e., CDMA transmission module. Examples of the CDMA module include: “Bluebird CDMA Module” made by Bluetree, “CM42” made by Sony-Ericson, and “SB-508” and “SB-519” made by Sierra-Wireless.

Also, radio frequency (RF) transmission modules may be used as the wireless transmission module 13. Further, network transmission modules such as for T1, T3, cable, and DSL transmission of the video data can be used.

Additionally, telephone transmission modules or modems may be used to transmit the video data via telephone wires.

In an exemplary embodiment of the invention, the video surveillance device 10 includes a video acquisition module 12 for each of the cellular, network, and telephone transmission modules.

In exemplary embodiments of the invention, the video surveillance device 10 can include more than one transmission module for simultaneous transmission by more than one transmission module. For example, the video surveillance device 10 can transmit the video output signal with an RF transmission module at the same time it transmits the video output signal with a cellular wireless transmission module. Also, if a telephone modem is included in the video surveillance device 10 along with a cellular wireless transmission module, the video surveillance device 10 can transmit the video output signal simultaneously over the cellular wireless transmission module and the telephone modem.

Due to the modular nature of the present invention, one or more of each type of transmission module may be used at a time to allow for simultaneous transmission of the video output signal via the plurality of transmission modules.

In an exemplary embodiment of the invention, the video surveillance device simultaneously transmits video data to four people, one via cellular transmission, one via network transmission, one via telephone transmission, and one via RF transmission. However, the invention is not limited to this combination of video transmissions. More than four transmissions can be performed at the same time, and any combination of types and numbers of transmissions can be performed simultaneously.

The antenna 14 receives the video output signal from the wireless transmission module 13 and transmits the video output signal. By using the wireless transmission module 13 and the antenna 14, the video surveillance device 10 does not have to be connected to a standard telephone line to transmit the video output signal. Thus, the video surveillance device 10 of the present invention can be used in a greater variety of locations than the conventional video surveillance device.

The battery 15 provides power to all of the components in the video surveillance device 10, which operates in either data transmission mode or standby mode. In data transmission mode, the video output signal is transmitted. While in standby mode, the video surveillance device 10 does not transmit the video output signal. In an exemplary embodiment, the battery has a capacity of 17 amps and provides up to 15 hours of data transmission time or operates for two weeks in standby mode. The battery 15 can be connected to a user selected external power source and recharged through the charger connector 17. As the external power source for charging the battery 15, a number of sources, such as a power supply battery charger or a solar panel can be used. Also, the external power source can be used to provide power to the video surveillance device 10. By providing battery power in the video surveillance device 10, an external power source at the site of the video surveillance device 10 is not required.

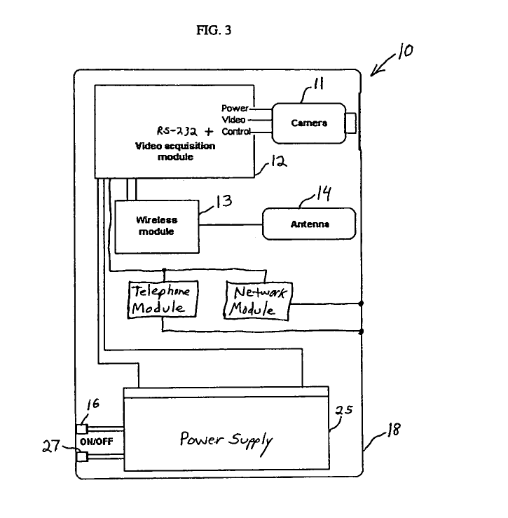

Since many applications of the video surveillance device 10 would be able to use an external source of power, another embodiment of the present invention provides a power supply 25 instead of the battery 15. See FIG. 3. The power supply 25 is powered by an external source of power, which is input to the video surveillance device through a connector 27. For example, the external power source would be a source of 110 VAC input to the power supply 25, which converts the AC voltage into DC voltage for supply to the components of the video surveillance device 10.

The video surveillance device 10 has a weatherproof enclosure 18 to allow for use in a variety of environments.

The ON/OFF switch 16 is used to turn on and turn off the video surveillance device 10.

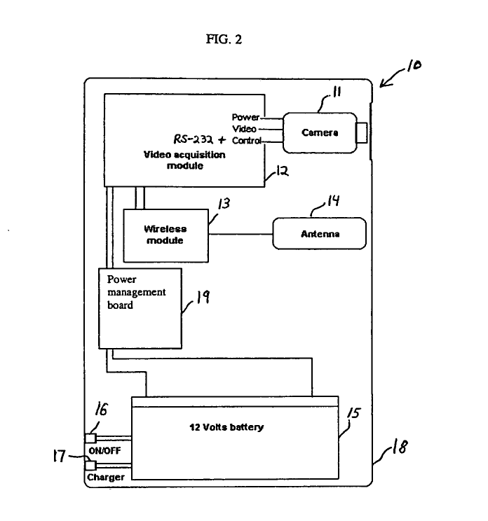

In another illustrative embodiment of the present invention, a power management board 19 is included, as shown in FIG. 2. The power management board 19 is connected between the battery 15 and the remaining components of the video surveillance device 10. The power management board 19 significantly decreases power consumption in the video surveillance device 10 during standby mode, by allowing power only to the wireless transmission module 13, when in standby mode.

Although the exemplary embodiments of the present invention have been described, it will be understood by those skilled in the art that the present invention should not be limited to the described preferred embodiments, but various changes and modifications can be made within the spirit and the scope of the present invention. Accordingly, the scope of the present invention is not limited within the described range but by the following claims.

1. A video surveillance device comprising:
a video acquisition module which acquires a video signal, processes the video signal, and outputs the processed video signal;
a wireless transmission module which transmits the output video signal; and
a power supply which provides power to the video acquisition module and the wireless transmission module.

2. The video surveillance device of claim 1, further comprising a video camera for outputting the video signal to the video acquisition module, wherein the power supply provides power to the video camera.

3. The video surveillance device of claim 1, further comprising a video data storage unit for outputting the video signal to the video acquisition module, wherein the power supply provides power to the video data storage unit.

4. The video surveillance device of claim 1, wherein the wireless transmission module comprises a GSM/GPRS transmission module.

5. The video surveillance device of claim 1, wherein the wireless transmission module comprises a CDMA transmission module.

6. The video surveillance device of claim 1, further comprising a network transmission module which transmits the output video signal.

7. The video surveillance device of claim 6, wherein the network transmission module comprises at least one of a T1 transmission module, a T3 transmission module, a cable transmission module, and a DSL transmission module.

8. The video surveillance device of claim 7, further comprising a telephone transmission module which transmits the output video signal.

9. The video surveillance device of claim 1, wherein the wireless transmission module comprises a radio frequency (RF) module.

10. The video surveillance device of claim 1, further comprising a weatherproof enclosure.

11. The video surveillance device of claim 1, further comprising an ON/OFF switch for turning the power supply ON and OFF.

12. The video surveillance device of claim 1, wherein the power supply comprises a battery.

13. The video surveillance device of claim 12, further comprising a charger connector for connecting a charging device to the battery to charge the battery.

14. The video surveillance device of claim 12, further comprising a power management board which supplies power only to the wireless transmission module when the video surveillance device is in a standby mode.

15. The video surveillance device of claim 1, wherein the video acquisition module processes the acquired video signal by digitizing and compressing the acquired video signal.

16. A video surveillance device comprising:
a plurality of video acquisition modules which acquire a video signal, process the video signal, and output the processed video signal;
a plurality of wireless transmission modules which transmit the output video signal; and
a power supply which provides power to the video acquisition modules and the wireless transmission modules.

17. The video surveillance device of claim 16, wherein the wireless transmission modules comprise at least one of a GSM/GPRS transmission module, a CDMA transmission module, and a radio frequency (RF) module.

18. The video surveillance device of claim 17, further comprising a network transmission module which transmits the output video signal.

19. The video surveillance device of claim 17, further comprising a telephone transmission module which transmits the output video signal.

20. The video surveillance device of claim 16, wherein the wireless transmission modules comprise a GSM/GPRS transmission module, a CDMA transmission module, and a radio frequency (RF) module.

21. The video surveillance device of claim 20, further comprising a network transmission module which transmits the output video signal.

22. The video surveillance device of claim 20, further comprising a telephone transmission module which transmits the output video signal.

23. The video surveillance device of claim 16, wherein the power supply comprises a battery.

24. The video surveillance device of claim 23, further comprising a charger connector for connecting a charging device to the battery to charge the battery.

25. The video surveillance device of claim 16, further comprising a video camera for outputting the video signal to the video acquisition modules, wherein the power supply provides power to the video camera.

26. The video surveillance device of claim 16, further comprising a video data storage unit for outputting the video signal to the video acquisition modules, wherein the power supply provides power to the video data storage unit.

27. The video surveillance device of claim 16, further comprising a weatherproof enclosure.

28. The video surveillance device of claim 16, further comprising an ON/OFF switch for turning the power supply ON and OFF.

29. The video surveillance device of claim 16, further comprising a power management board which supplies power only to the wireless transmission module when the video surveillance device is in a standby mode.

30. The video surveillance device of claim 16, wherein the video acquisition modules process the acquired video signal by digitizing and compressing the acquired video signal.
